(19) United States
(12) Patent Application Publication
(10) Pub. No.: US 2016/0358269 A1
(43) Pub. Date: Dec. 8, 2016

(54) SYSTEMS AND METHODS FOR ASSISTING PUBLIC ACTIVITIES OF CITIZENS

(71) Applicant: MIKHAIL TALANOV, Berkeley, CA (US)

(72) Inventor: MIKHAIL TALANOV, Berkeley, CA (US)

(21) Appl. No.: 14/732,785

(22) Filed: Jun. 8, 2015

(51) Int. Cl. G06Q 50/00; G06F 3/0484; G06F 3/0481

(52) U.S. Cl. CPC G06Q 50/01; G06F 3/0481; G06F 3/04847

(57) ABSTRACT

A computer-implemented method for assisting ordinary citizens with their public activities, such as participation in elections, public gatherings and interest group meetings, the method being performed in a computerized system comprising a central processing unit, a localization signal receiver, a display device and a memory, the computer-implemented method comprising: generating a graphical user interface on the display device; using the graphical user interface to perform a registration of a user; using the graphical user interface to receive from the user a designation of a plurality of political topics of interest to the user; providing the user with information with respect to the designated plurality of political topics of interest to the user; using the localization signal receiver to determine a location of the user; and assisting the user with the public activities using the determined location of the user and a time information.

### BACKGROUND OF THE INVENTION

### Technical Field

The disclosed embodiments relate in general to systems and methods for assisting ordinary citizens with their public activities, such as participation in elections, public gatherings and interest group meetings.

### Description of the Related Art

Citizens often use social networks to share information on political events, such as public gatherings, discuss election candidates and their programs on various issues and engage in other socially important activities. Unfortunately, conventional social networks are not well suited to this type of interaction as they lack necessary specialized functionality.

Thus, a specialized systems and methods for assisting ordinary citizens with their public activities, such as participation in elections, public gatherings and interest group meetings would be highly desirable.

### SUMMARY OF THE INVENTION

The embodiments described herein are directed to methods and systems that substantially obviate one or more of the above and other problems associated with using conventional social networks for assisting ordinary citizens with their public activities, such as participation in elections, public gatherings and interest group meetings.

In accordance with one aspect of the inventive concepts described herein, there is provided a computer-implemented method for assisting ordinary citizens with their public activities, such as participation in elections, public gatherings and interest group meetings, the method being performed in a computerized system comprising a central processing unit, a localization signal receiver, a display device and a memory, the computer-implemented method comprising: generating a graphical user interface on the display device; using the graphical user interface to perform a registration of a user; using the graphical user interface to receive from the user a designation of a plurality of political topics of interest to the user; providing the user with information with respect to the designated plurality of political topics of interest to the user; using the localization signal receiver to determine a location of the user; and assisting the user with the public activities using the determined location of the user and a time information.

In one or more embodiments, assisting the user comprises showing the user a location of a voting booth.

In one or more embodiments, assisting the user comprises showing the user a path a voting booth.

In one or more embodiments, assisting the user comprises performing a check-in of the user at a voting booth.

In one or more embodiments, assisting the user comprises receiving information from the user on user's voting choices and aggregating the received information in a database.

In one or more embodiments, assisting the user comprises enabling a user to invite friends.

In one or more embodiments, assisting the user comprises enabling a user to send one or more messages.

In accordance with another aspect of the inventive concepts described herein, there is provided a non-transitory computer-readable medium embodying a set of computer-executable instructions, which, when executed in connection with a computerized system comprising a central processing unit, a localization signal receiver, a display device and a memory, cause the computerized system to perform a method for assisting ordinary citizens with their public activities, such as participation in elections, public gatherings and interest group meetings, the method comprising: generating a graphical user interface on the display device; using the graphical user interface to perform a registration of a user; using the graphical user interface to receive from the user a designation of a plurality of political topics of interest to the user; providing the user with information with respect to the designated plurality of political topics of interest to the user; using the localization signal receiver to determine a location of the user; and assisting the user with the public activities using the determined location of the user and a time information.

In one or more embodiments, assisting the user comprises showing the user a location of a voting booth.

In one or more embodiments, assisting the user comprises showing the user a path a voting booth.

In one or more embodiments, assisting the user comprises performing a check-in of the user at a voting booth.

In one or more embodiments, assisting the user comprises receiving information from the user on user's voting choices and aggregating the received information in a database.

In one or more embodiments, assisting the user comprises enabling a user to invite friends.

In one or more embodiments, assisting the user comprises enabling a user to send one or more messages.

In accordance with yet another aspect of the inventive concepts described herein, there is provided a computerized system for assisting ordinary citizens with their public activities, such as participation in elections, public gatherings and interest group meetings, comprising a central processing unit, a localization signal receiver, display device and a memory, the memory storing a set of computer-readable instructions causing the computerized system to perform a method comprising: generating a graphical user interface on the display device; using the graphical user interface to perform a registration of a user; using the graphical user interface to receive from the user a designation of a plurality of political topics of interest to the user; providing the user with information with respect to the designated plurality of political topics of interest to the user; using the localization signal receiver to determine a location of the user; and assisting the user with the public activities using the determined location of the user and a time information.

In one or more embodiments, assisting the user comprises showing the user a location of a voting booth.

In one or more embodiments, assisting the user comprises showing the user a path a voting booth.

In one or more embodiments, assisting the user comprises performing a check-in of the user at a voting booth.

In one or more embodiments, assisting the user comprises receiving information from the user on user's voting choices and aggregating the received information in a database.

In one or more embodiments, assisting the user comprises enabling a user to invite friends.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of a high level diagram of an computing platform used in the disclosed embodiments.

FIG. 2 illustrates an aspect of an embodiment of the computing platform used in the disclosed embodiments.

FIG. 3 is an exemplary block scheme of an operating sequence of an embodiment of the described platform.

FIG. 4(a) illustrates an exemplary interface of the client system during the registration process.

FIG. 4(b) illustrates an exemplary interface of the client system during the second step of the registration process.

FIG. 4(c) illustrates an exemplary graphical user interface screen generated by the client system, which shows other users of the inventive platform in the proximity of the user.

FIG. 4(d) illustrates an exemplary graphical user interface screen of the client system for enabling users to invite other users to the platform

FIG. 4(e) illustrates an exemplary graphical user interface screen of the client system for adaptively providing the user with various information based on user's choices described above.

FIGS. 4(f) and 4(g) illustrate exemplary the exemplary graphical user interfaces of the inventive platform shown to the user on an election day.

FIG. 4(h) illustrates an exemplary embodiment of a graphical user interface screen of the platform for the election day functionality, which is activated using the Election widget.

FIG. 4(i) illustrates an exemplary embodiment of a graphical user interface created on the client computing system of the platform, wherein the user may generate and send a message to the manager of a political campaign during a pre-election engagement.

FIG. 4(j) illustrates an exemplary embodiment of a graphical user interface of the client computing system, wherein every user may see how many friends he invited to the platform.

FIG. 5 illustrates an exemplary data storage configuration of the inventive platform including two databases: 1) a database of users and 2) a voting booth database.

FIG. 6 illustrates an exemplary embodiment of a computerized mobile system that could be used as the client device in connection with the localization system illustrated in FIG. 1.

FIG. 7 illustrates an exemplary embodiment of a computerized server system, which could be used, for example, as the central server of the localization system shown in FIG. 1.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

To address the above and other problems associated with the conventional technology, one or more embodiments described herein implement a system and method that provide assistance to citizens with their public activities, such as participation in elections, public gatherings and interest group meetings. These systems keep citizens informed of the opportunities for public activities, such as participation in elections, public gatherings and interest group meetings and also provide an inter-citizen connection mechanism as well as a discussion platform.

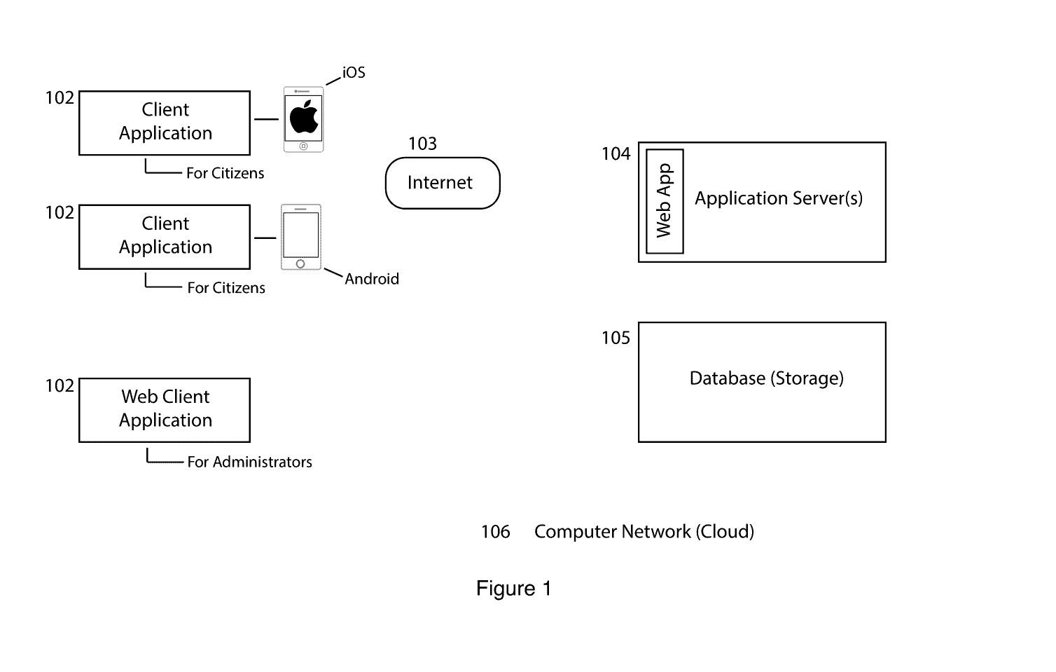

FIG. 1 illustrates an exemplary embodiment of a high level diagram of an computing platform used in the disclosed embodiments. In one embodiment, the servers, databases, web-application servers 104 and 105 as well as development tools shown in FIG. 1 are located in a cloud (computer network) 106. The platform connects to the clients using Internet 103. In one embodiment, the users access the capabilities provided by the described system using iOS and/or Android client computing devices 102. In the same or different embodiment, the described system is also managed using the aforesaid iOS and/or Android client devices 102 or using a web client application 102.

As would be appreciated by persons of ordinary skill in the art, the aforesaid mobile platforms (iOS and/or Android, well known to persons of ordinary skill in the art) give users enormous advantages, because the described platform is geo-position and time-based, as well as capable of upgrading/amending the content in the systems using functionality of auto-upgrade in Apple Store and Google market. In one exemplary embodiment, the described platform can be accessed only using the iOS and Android clients and does not exist for a classical web server.

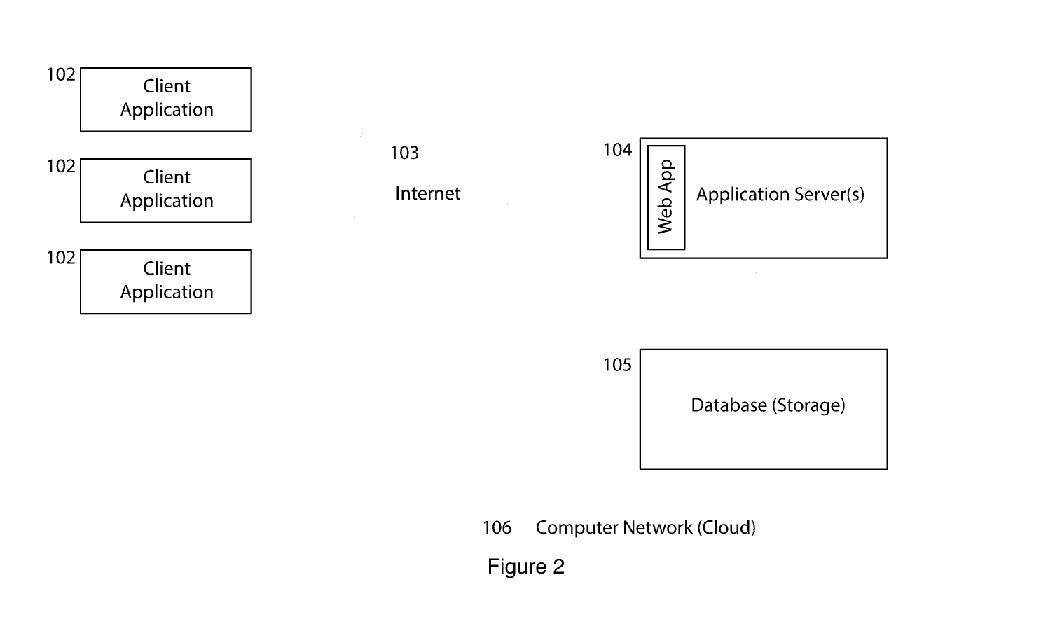

FIG. 2 illustrates an aspect of an embodiment of the computing platform used in the disclosed embodiments.

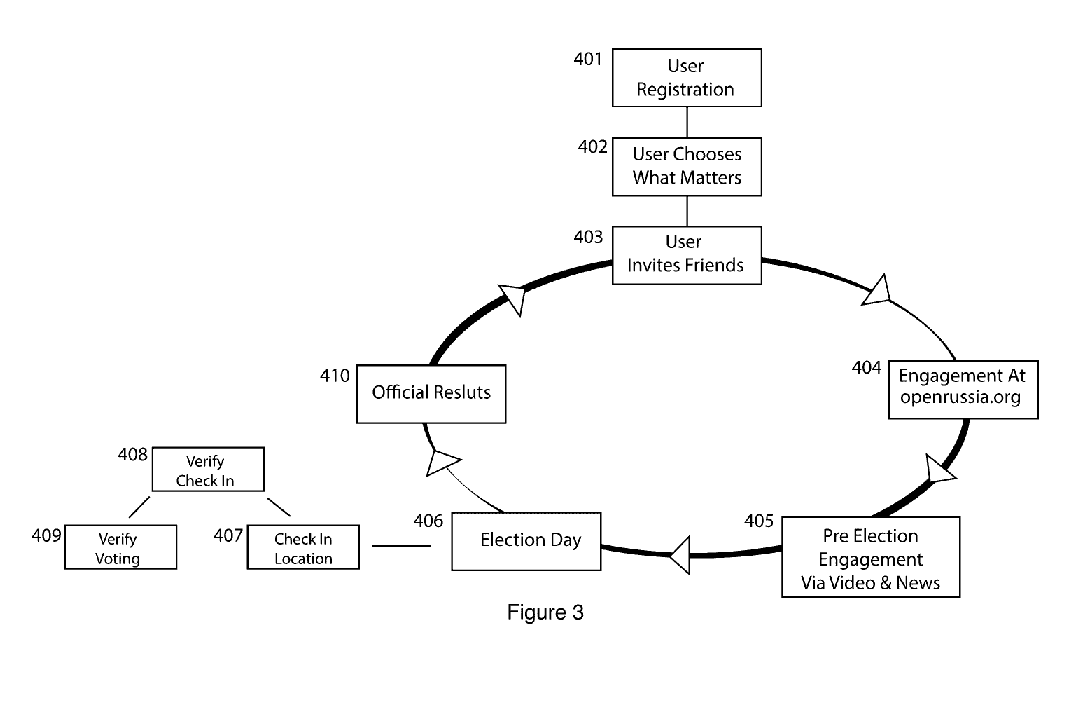

FIG. 3 is an exemplary block scheme of an operating sequence of an embodiment of the described platform. In one or more embodiments, the user performs the following main steps. First, at step 401, the user registers with the system, providing his contact information and credentials. The registration may be performed using the iOS and Android clients 102. At step 402, the user uses the iOS and Android clients to select topics of interest to the user. At step 403, the user uses the graphical user interface of the iOS and Android clients 102 to invite his or her friends to use the platform.

During further steps, the user interacts with the platform, which assists the user in his or her public activities. For example, at step 404, the user may engage at openrussi.org or other resources available over the Internet. At step 405, the user may participate in pre-election engagement via video and news resources. Further, on the election day 406, the user may check in a location at step 407, verify check-in and step 408 and verify voting at step 409. Finally, official election results may be viewed at step 410. In one or more embodiments, there is provided an engagement with the platform where during the day of election user will have additional functionality to check on voting booth and see results based on his voting booth by means of exit pools.

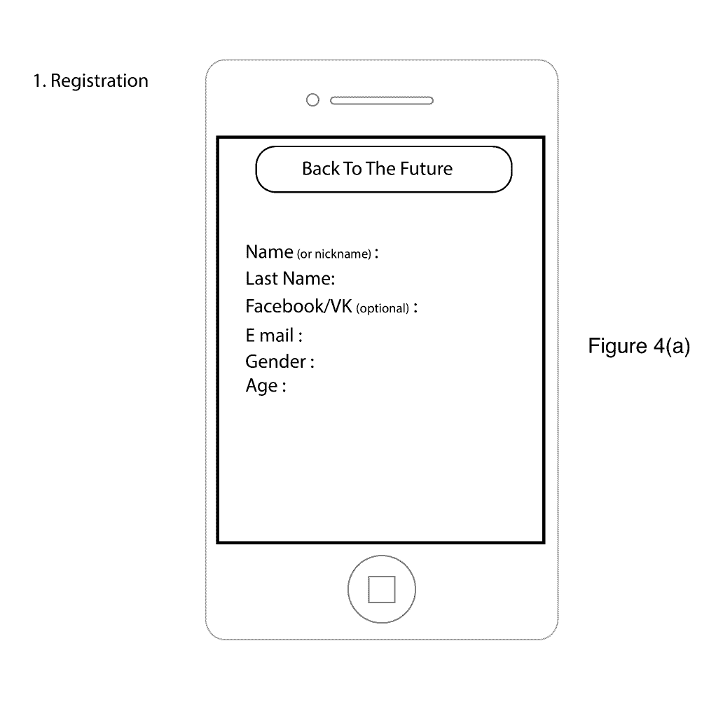

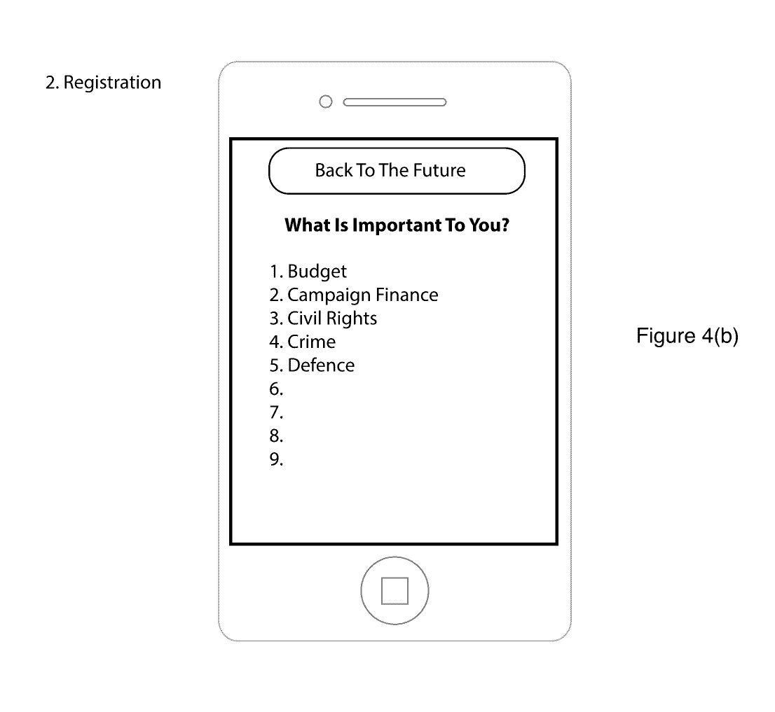

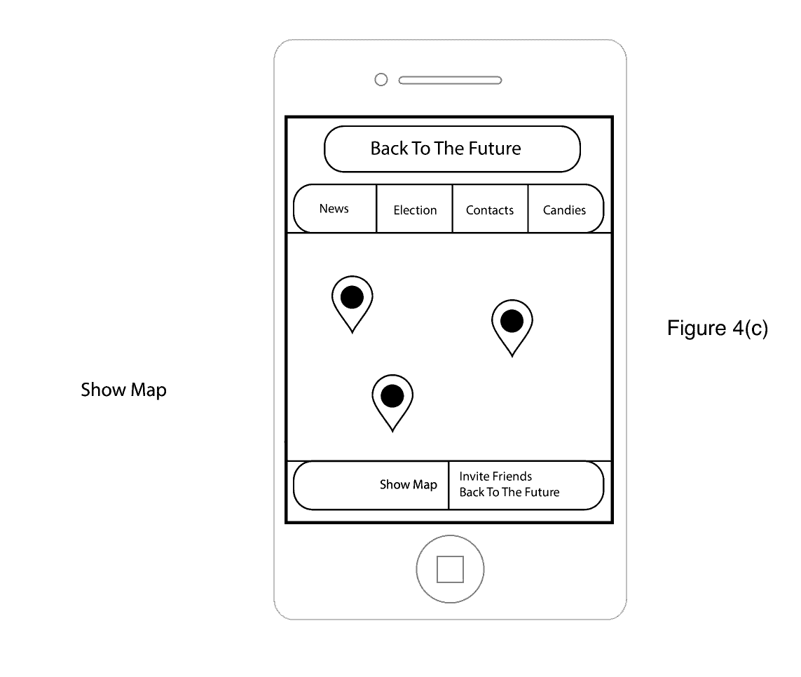

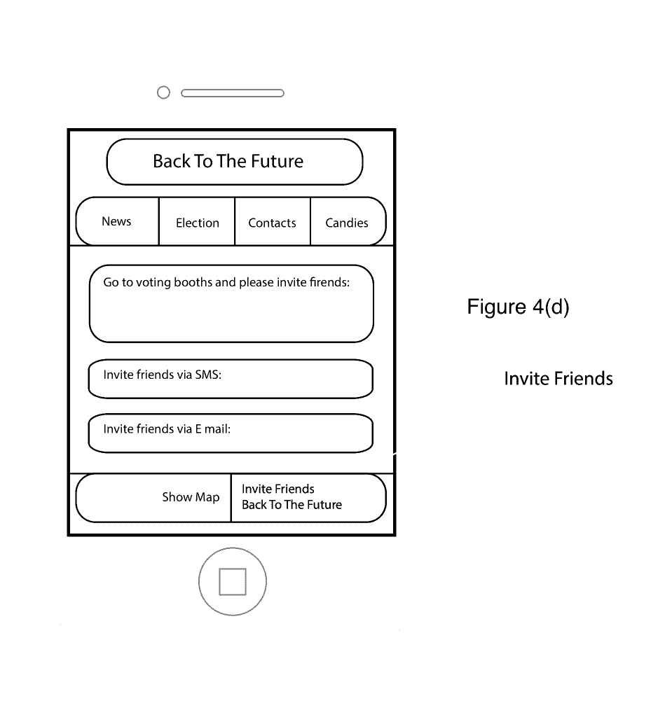

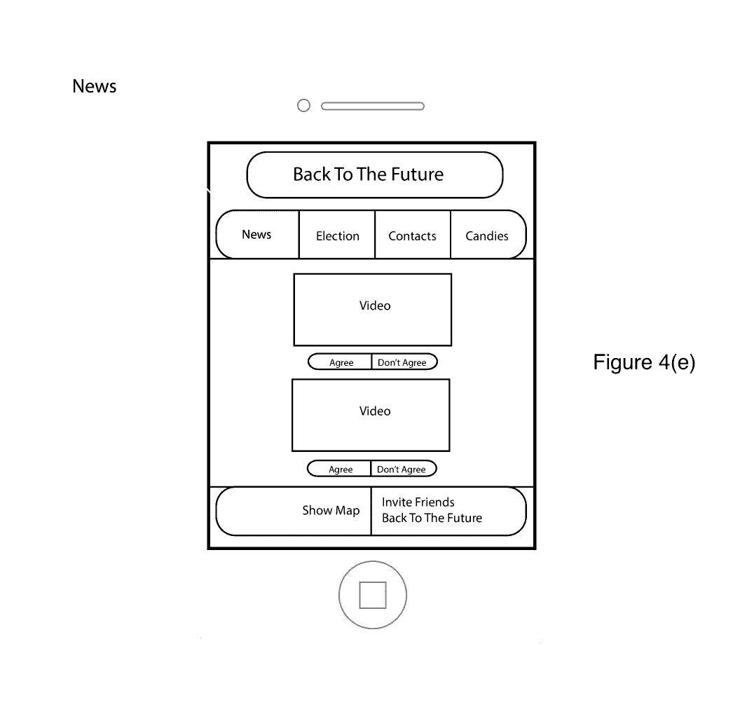

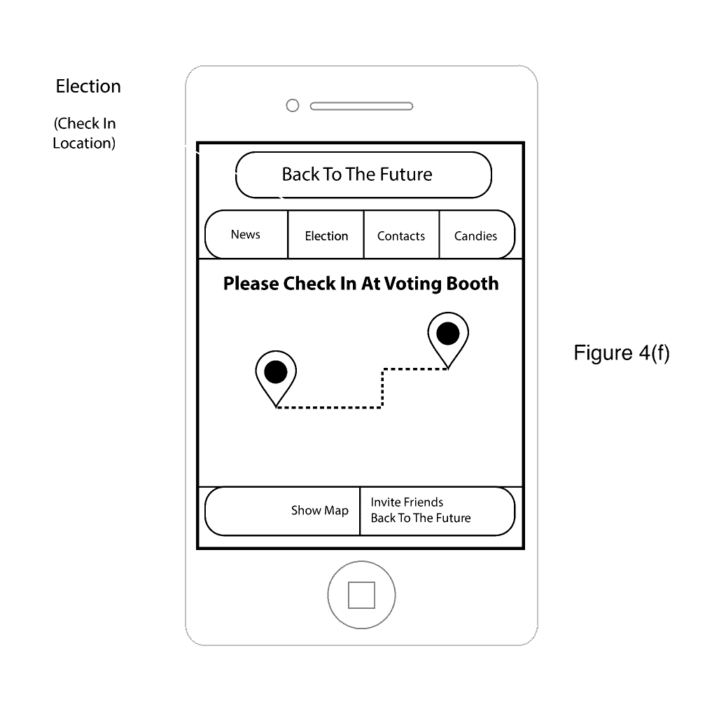

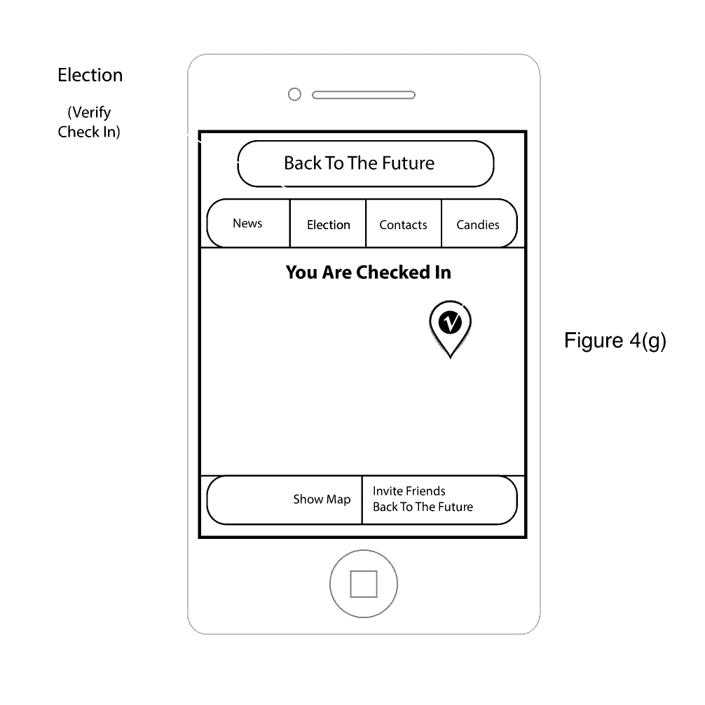

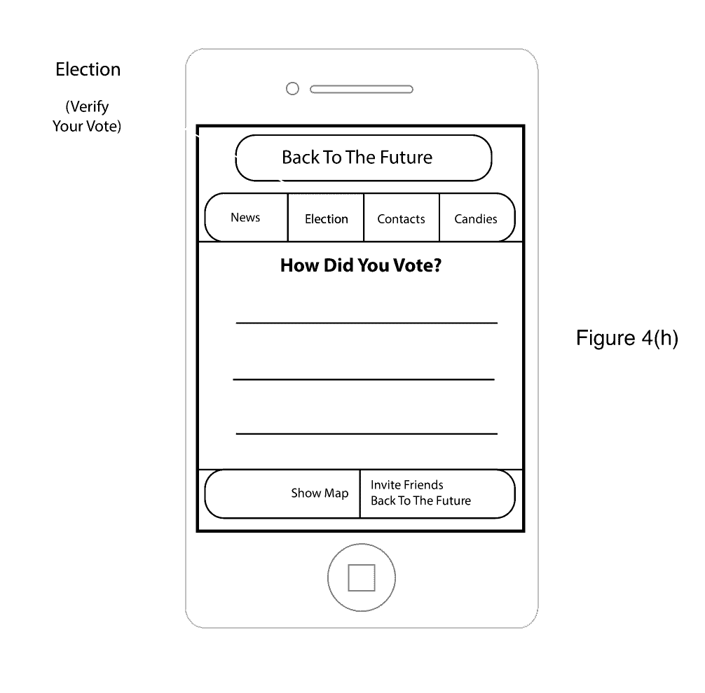

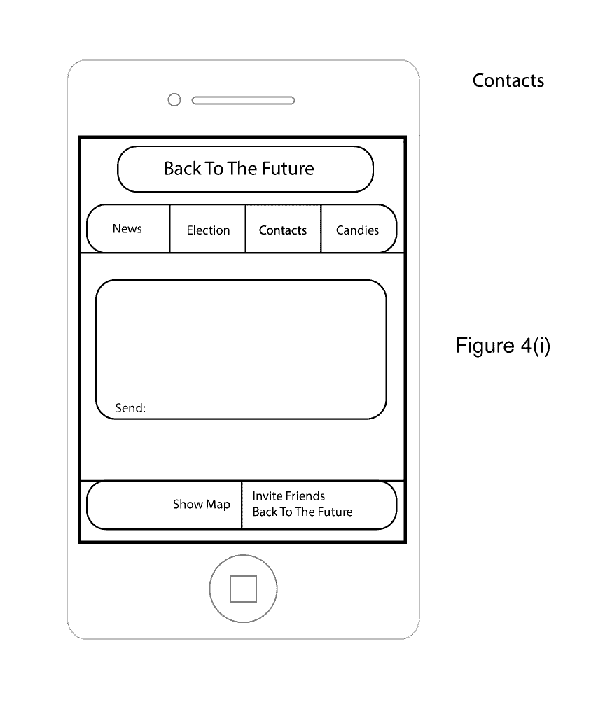

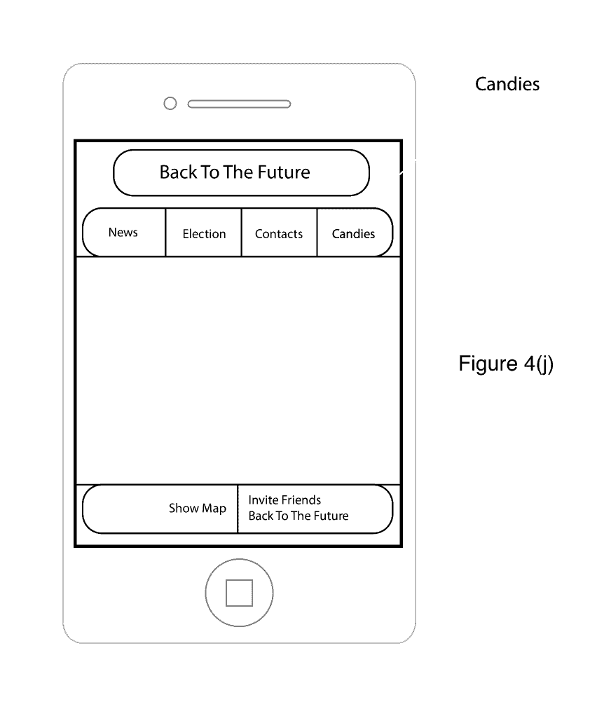

FIG. 4(a) illustrates an exemplary interface of the client system 102 during the registration process. Specifically, as shown in FIG. 4(a), the registration screen requires the user to provide his name, last name, social networking profile information, email address, gender and age.

FIG. 4(b) illustrates an exemplary interface of the client system 102 during the second step of the registration process. In one embodiment, the user is asked to pick three important topics from a presented topic list. Based on the choice of the user, the platform is configured to upload candidate's programs in relation to the selected topics. Exemplary champagne topics may include budget, champagne finance, and the like. The invention is obviously not limited to a list of any specific topics and other relevant topics may be added from time to time by the platform's administrator.

FIG. 4(c) illustrates an exemplary graphical user interface screen generated by the client system 102, which shows other users of the inventive platform in the proximity of the user. The main goal of the aforesaid user interface screen is to encourage users to enlist their friends in to the platform and build the power of a united team of users of the platform.

FIG. 4(d) illustrates an exemplary graphical user interface screen of the client system 102 for enabling users to invite other users to the platform. This screen appears when the user activates the “Invite Friends” widget of the graphical user interface of the client system 102. In various embodiments, the friends may be invited using SMS or email. To this end, the user enters friends' contact information into the corresponding fields and the platform sends necessary invitation containing information about downloading the corresponding mobile application. The aforesaid invitation may include a URL or other appropriate location identifier.

In one embodiment, the graphical user interface incorporates four graphical user interface widgets (tabs) near the top of the screen, including “News”, “elections, “Contacts” and “Candies.” Upon detection of the user activating one of the tabs, the corresponding screen of the graphical user interface screen of the client system 102 is shown to the user.

FIG. 4(e) illustrates an exemplary graphical user interface screen of the client system 102 for adaptively providing the user with various information based on user's choices described above. This screen becomes active when the user selects the “News” graphical user interface widget, see FIG. 4(e). In one embodiment, this is the main engagement screen for the user. In one or more embodiments, the aforesaid screen incorporates one or more videos shown to the user. The videos shown to the user are uploaded to the client system 102 from cloud and selected based on the topics of interest to the user identified by the user during the aforesaid second step of the registration process.

FIGS. 4(f) and 4(g) illustrate exemplary the exemplary graphical user interfaces of the inventive platform shown to the user on an election day. To determine election day the platform stores election dates, times and descriptions for various localities (countries, states, regions, cities, etc.). In one embodiment, the graphical user interfaces show to the user where on a map the voting booths are located, including the closest to the user location. In one embodiment, the exemplary graphical user interfaces may draw a walking or driving path to the chosen voting booth to assist the user in election participation.

In one or more embodiments, the platform additionally provides the user with an ability to check in at the voting booth using additional security measures, such as a pass code, see FIG. 4(g). In this embodiment, the platform sends a notification, such as SMS or email message, to user's friends notifying them that “this user has voted”. As would be appreciated by persons of ordinary skill in the art, this feature would encourage user's to vote.

FIG. 4(h) illustrates an exemplary embodiment of a graphical user interface screen of the platform for the election day functionality, which is activated using the Election widget. Specifically, this embodiment of the user interface is a classical exit-pool screen wherein the user may (but does not have to) provide the results of his voting. To this end, the graphical user interface screen contains a data entry field entitled “How Did You Vote?” in which the user may input his voting choices. The information from the user's client device is then sent to the cloud server, wherein it is securely stored.

FIG. 4(i) illustrates an exemplary embodiment of a graphical user interface created on the client computing system 102 of the platform, wherein the user may generate and send a message to the manager of a political campaign during a pre-election engagement. To this end, the graphical user interface incorporates a message entry field and a send widget. As would be appreciated by persons of ordinary skill in the art, such functionality of the inventive platform would encourage young people to get engaged into political activities.

FIG. 4(j) illustrates an exemplary embodiment of a graphical user interface of the client computing system 102, wherein every user may see how many friends he invited to the platform. In one embodiment, the leader will have direct access to a manager of political campaign and may address his political willingness to participate in elections actively.

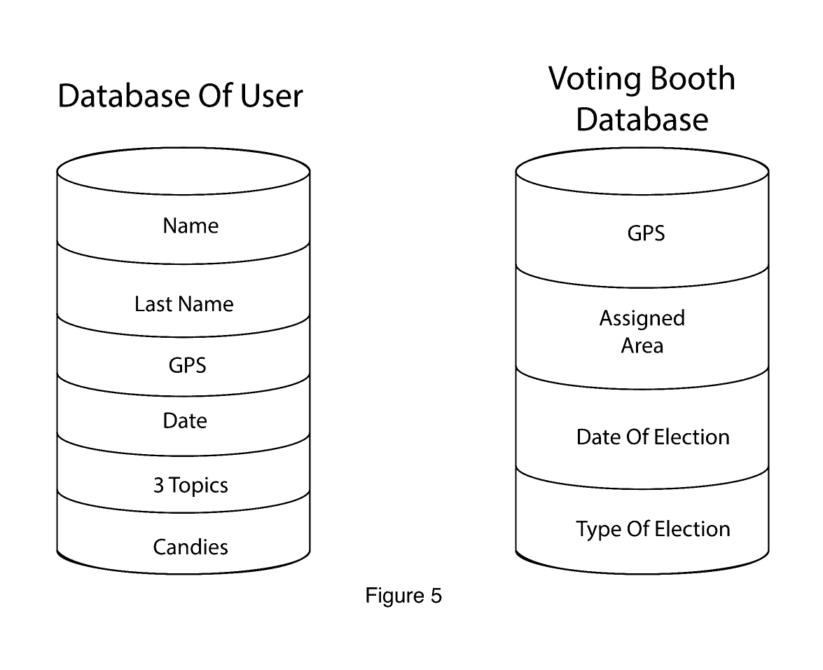

FIG. 5 illustrates an exemplary data storage configuration of the inventive platform including two databases: 1) a database of users and 2) a voting booth database. In one embodiment, the platform collects specific information from every user to match him or her with his designated voting booth on the coming election day. In one embodiment, the matching is time and geo-location based. FIG. 5 illustrates the data records stored in the respective databases, including name, last name, GPS location, date, topics, candies for the first database and GPS location, assigned area, date of election and type of election in the second database.

### Computing Platforms

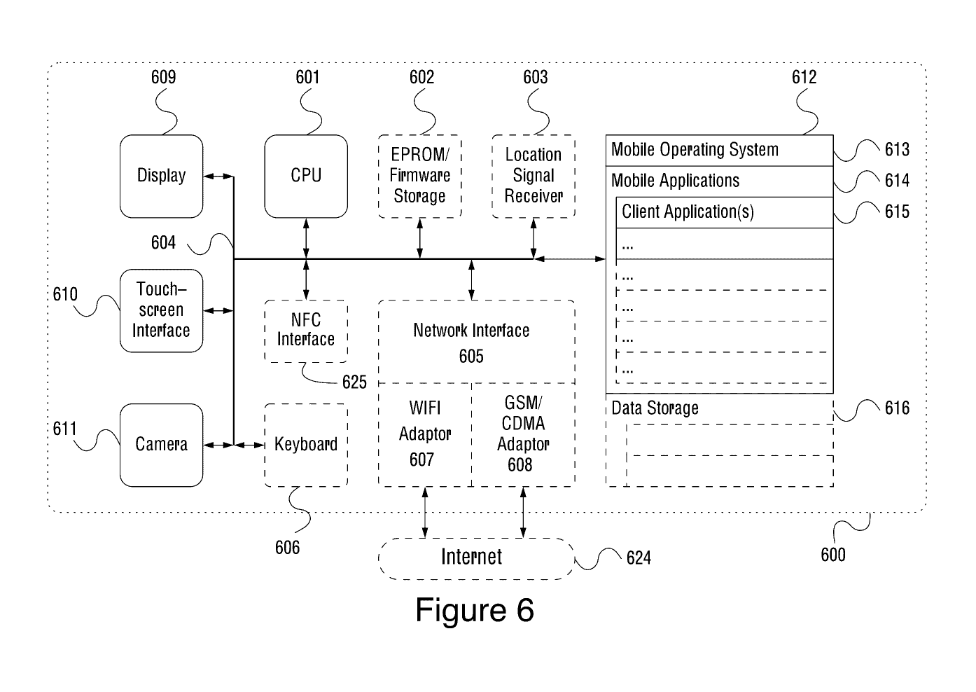

FIG. 6 illustrates an exemplary embodiment of a computerized mobile system 600 that could be used as the client device 102 in connection with the system shown in FIG. 1. In one or more embodiments, the computerized mobile system 600 may be implemented within a form factor of a mobile computing device, such as a smartphone, a personal digital assistant (PDA), a tablet computer, or a smart watch, all of which are widely available commercially and are well known to persons of skill in the art.

The computerized system 600 may include a data bus 604 or other interconnect or communication mechanism for communicating information across and among various hardware components of the mobile computerized system 600, and a central processing unit (CPU or simply processor) 601 coupled with the data bus 604 for processing information and performing other computational and control tasks. Computerized system 600 also includes a memory 612, such as a random access memory (RAM) or other dynamic storage device, coupled to the data bus 604 for storing various information as well as instructions to be executed by the processor 601. The memory 612 may also include persistent storage devices, such as a magnetic disk, optical disk, solid-state flash memory device or other non-volatile solid-state storage devices.

In one or more embodiments, the memory 612 may also be used for storing temporary variables or other intermediate information during execution of instructions by the processor 601. Optionally, computerized system 600 may further include a read only memory (ROM or EPROM) 602 or other static storage device coupled to the data bus 604 for storing static information and instructions for the processor 601, such as firmware necessary for the operation of the computerized system 600, basic input-output system (BIOS), as well as various configuration parameters of the computerized system 600.

In one or more embodiments, the computerized system 600 may incorporate a display device 609, which may be also coupled to the data bus 604, for displaying various information to a user of the computerized system 600. In an alternative embodiment, the display device 609 may be associated with a graphics controller and/or graphics processor (not shown). The display device 609 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 609 may be incorporated into the same general enclosure with the remaining components of the computerized system 600. In an alternative embodiment, the display device 609 may be positioned outside of such enclosure.

In one or more embodiments, the computerized system 600 may further incorporate an near field communication (NFC) interface 625 connected to the data bus 604 and configured to communicate with one or more NFC devices in the building as described above.

In one or more embodiments, the computerized system 600 may incorporate one or more input devices, such as a touchscreen interface 610 for receiving tactile commands, a camera 611 for acquiring still images and video of various objects, such as user's faces or room surroundings, as well as a keyboard 606, which all may be coupled to the aforesaid data bus 604 for communicating information, including, without limitation, images and video, as well as user command selections to the processor 601. In an alternative embodiment, input devices may include a system for tracking eye movements of the user (not shown), which may be used to indicate to the computerized system 600 the command selection by the user.

In one or more embodiments, the computerized system 600 may additionally include a location signal receiver 603 configured to perform scan for GPS signal or beacons and supply scan data described above to the processor 601 via the data bus 604.

In one or more embodiments, the computerized system 600 may additionally include a communication interface, such as a network interface 905 coupled to the data bus 604. The network interface 605 may be configured to establish a connection between the computerized system 600 and the Internet 6924 using at least one of WIFI interface 607 and the cellular network (GSM or CDMA) adaptor 608. The network interface 605 may be configured to provide a two-way data communication between the computerized system 600 and the Internet 624. The WIFI interface 607 may operate in compliance with 802.11a, 802.11b, 802.11g and/or 802.11n protocols as well as Bluetooth protocol well known to persons of ordinary skill in the art. In an exemplary implementation, the WIFI interface 607 and the cellular network (GSM or CDMA) adaptor 608 send and receive electrical or electromagnetic signals that carry digital data streams representing various types of information.

In one or more embodiments, the Internet 624 typically provides data communication through one or more sub-networks to other network resources. Thus, the computerized system 600 is capable of accessing a variety of network resources located anywhere on the Internet 624, such as web servers, other content servers as well as other network data storage resources. In one or more embodiments, the computerized system 600 is configured send and receive messages, media and other data, including application program code, through a variety of network(s) including Internet 624 by means of the network interface 605. In the Internet example, when the computerized system 600 acts as a network client, it may request code or data for an application program executing on the computerized system 600. Similarly, it may send various data or computer code to other network resources.

In one or more embodiments, the computerized system 600 uses the network interface 605 to send request(s), via the Internet 624, such as HTTP requests, to the cloud servers and receive various information, including, without limitation, the aforesaid location information and the timestamp, therefrom.

In one or more embodiments, the functionality described herein is implemented by computerized system 600 in response to processor 601 executing one or more sequences of one or more instructions contained in the memory 612. Such instructions may be read into the memory 612 from another computer-readable medium. Execution of the sequences of instructions contained in the memory 612 causes the processor 601 to perform the various process steps described herein. In alternative embodiments, hard-wired circuitry may be used in place of or in combination with software instructions to implement the embodiments of the invention. Thus, embodiments of the invention are not limited to any specific combination of hardware circuitry and software.

The term “computer-readable medium” as used herein refers to any medium that participates in providing instructions to processor 601 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 901 for execution. For example, the instructions may initially be carried on a magnetic disk from a remote computer. Alternatively, a remote computer can load the instructions into its dynamic memory and send the instructions over the Internet 624. Specifically, the computer instructions may be downloaded into the memory 612 of the computerized system 600 from the foresaid remote computer via the Internet 624 using a variety of network data communication protocols well known in the art.

In one or more embodiments, the memory 612 of the computerized system 600 may store any of the following software programs, applications or modules:

1. Operating system (OS) 613, which may be a mobile operating system for implementing basic system services and managing various hardware components of the computerized system 600. Exemplary embodiments of the operating system 613 are well known to persons of skill in the art, and may include any now known or later developed mobile operating systems.

2. Mobile applications 614 may include, for example, a set of software applications executed by the processor 601 of the computerized system 600, which cause the computerized mobile system 600 to perform certain predetermined functions, such as receive the beacon signals as described above. In one or more embodiments, the mobile applications 614 may include, for example, the platform client application 615.

3. Data storage 616 may be used, for example, for storing client location information as well as other data.

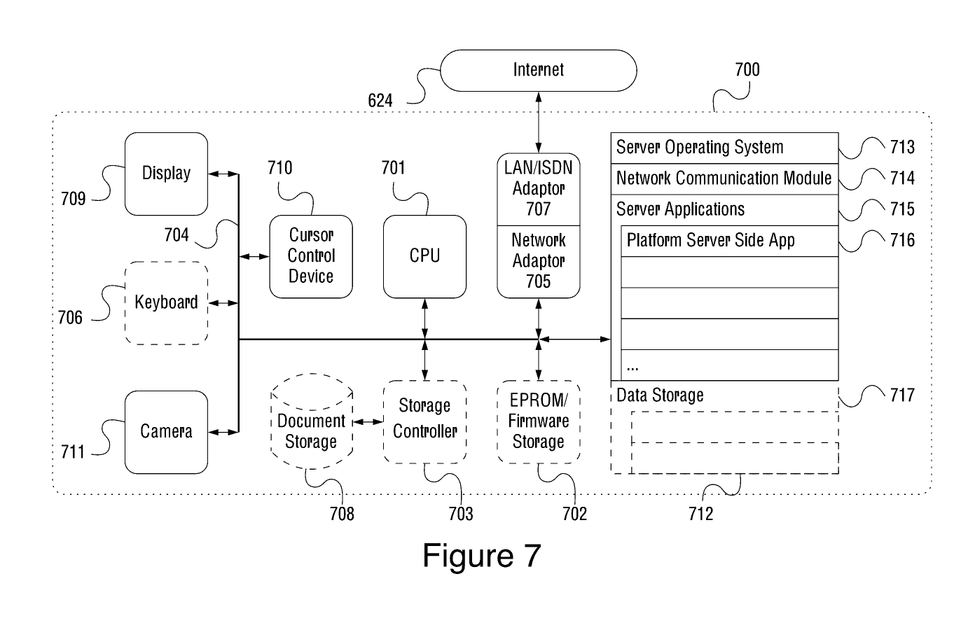

FIG. 7 illustrates an exemplary embodiment of a computerized server system 700 which could be used, for example, as the application servers 104 of the system shown in FIG. 1. It should be noted that other components of the platform such as the database 105 may be also deployed on the computerized server system 700.

In one or more embodiments, the computerized server system 700 may incorporate a data bus 704, which may be substantially similar and may perform substantially similar functions as the data bus 704 of the computerized system 600 illustrated in FIG. 6. In various embodiments, the data bus 704 may use the same or different interconnect and/or communication protocol as the data bus 604. The one or more processors (CPUs) 701, the network adaptor 705, the EPROM/Firmware storage 702, the display device 709 and the keyboard 706 of the computerized server system 700 may be likewise substantially similar to the respective processor 601, the network interface 605, the EPROM/Firmware storage 602, the display device 609 and the keyboard 606 of the computerized system 600, except that the former components are deployed in a server platform configuration. In various implementations, the one or more processor 701 may have substantially increased processing power as compared with the processor 601.

In addition to the input device 706 (keyboard), the computerized server system 700 may additionally include a cursor control device 710, such as a mouse, a trackball, or cursor direction keys for communicating direction information and command selections to processor 701 and for controlling cursor movement on the display device 709. This input device typically has two degrees of freedom in two axes, a first axis (e.g., x) and a second axis (e.g., y), that allows the device to specify positions in a plane.

The LAN/ISDN adaptor 707 of the computerized server system 700 may be implemented, for example, using an integrated services digital network (ISDN) card or a modem to provide a data communication connection to a corresponding type of telephone line, which is interfaced with the Internet 624 using Internet service provider's hardware (not shown). As another example, the LAN/ISDN adaptor 707 may be a local area network interface card (LAN NIC) to provide a data communication connection to a compatible LAN and the Internet 624. To store various media files, the computerized server system 700 may be provided with document storage 708, for storing various content to be displayed to the user by means of a storage controller 703. The camera 711 may be used to acquire images and/or video of various objects.

In one or more embodiments, the memory 712 of the computerized server system 700 may store any of the following software programs, applications, modules and/or data:

1. A server operating system (OS) 713, which may be an operating system for implementing basic system services and managing various hardware components of the computerized server system 700. Exemplary embodiments of the server operating system 713 are all well known to persons of skill in the art, and may include any now known or later developed operating systems.

2. A network communication module 714 may incorporate, for example, one or more network protocol stacks which are used to establish a networking connection between the computerized server system 700 and the various network entities of the Internet 624, such as the computerized mobile system 600, using the network adaptor 705 working in conjunction with the LAN/ISDN adaptor 707.

3. Server applications 615 may include, for example, a set of software applications executed by one or more processors 701 of the computerized server system 700, which cause the computerized server system 700 to perform certain predetermined functions or tasks. In one or more embodiments, the server applications 715 may include the platform server side application 716. Additionally provided may be a database management system 717 for storing the information shown in FIG. 5.

4. Data storage 719 may be used, for example, for storing the data structures shown in FIG. 5, which may be stored in a form of one or more database tables.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in various systems and methods for assisting ordinary citizens with their public activities, such as participation in elections, public gatherings and interest group meetings. It is intended that the specification and examples be considered as exemplary only, with a true scope and spirit of the invention being indicated by the following claims.

What is claimed is:

1. A computer-implemented method for assisting ordinary citizens with their public activities, such as participation in elections, public gatherings and interest group meetings, the method being performed in a computerized system comprising a central processing unit, a localization signal receiver, a display device and a memory, the computer-implemented method comprising:
a. generating a graphical user interface on the display device;
b. using the graphical user interface to perform a registration of a user;
c. using the graphical user interface to receive from the user a designation of a plurality of political topics of interest to the user;
d. providing the user with information with respect to the designated plurality of political topics of interest to the user;
e. using the localization signal receiver to determine a location of the user; and
f assisting the user with the public activities using the determined location of the user and a time information.

2. The computer-implemented method of claim 1, wherein assisting the user comprises showing the user a location of a voting booth.

3. The computer-implemented method of claim 1, wherein assisting the user comprises showing the user a path a voting booth.

4. The computer-implemented method of claim 1, wherein assisting the user comprises performing a check-in of the user at a voting booth.

5. The computer-implemented method of claim 1, wherein assisting the user comprises receiving information from the user on user's voting choices and aggregating the received information in a database.

6. The computer-implemented method of claim 1, wherein assisting the user comprises enabling a user to invite friends.

7. The computer-implemented method of claim 1, wherein assisting the user comprises enabling a user to send one or more messages.

8. A non-transitory computer-readable medium embodying a set of computer-executable instructions, which, when executed in connection with a computerized system comprising a central processing unit, a localization signal receiver, a display device and a memory, cause the computerized system to perform a method for assisting ordinary citizens with their public activities, such as participation in elections, public gatherings and interest group meetings, the method comprising:
a. generating a graphical user interface on the display device;
b. using the graphical user interface to perform a registration of a user;
c. using the graphical user interface to receive from the user a designation of a plurality of political topics of interest to the user;
d. providing the user with information with respect to the designated plurality of political topics of interest to the user;
e. using the localization signal receiver to determine a location of the user; and
f. assisting the user with the public activities using the determined location of the user and a time information.

9. The non-transitory computer-readable medium of claim 8, wherein assisting the user comprises showing the user a location of a voting booth.

10. The non-transitory computer-readable medium of claim 8, wherein assisting the user comprises showing the user a path a voting booth.

11. The non-transitory computer-readable medium of claim 8, wherein assisting the user comprises performing a check-in of the user at a voting booth.

12. The non-transitory computer-readable medium of claim 8, wherein assisting the user comprises receiving information from the user on user's voting choices and aggregating the received information in a database.

13. The non-transitory computer-readable medium of claim 8, wherein assisting the user comprises enabling a user to invite friends.

14. The non-transitory computer-readable medium of claim 8, wherein assisting the user comprises enabling a user to send one or more messages.

15. A computerized system for assisting ordinary citizens with their public activities, such as participation in elections, public gatherings and interest group meetings, comprising a central processing unit, a localization signal receiver, display device and a memory, the memory storing a set of computer-readable instructions causing the computerized system to perform a method comprising:
a. generating a graphical user interface on the display device;
b. using the graphical user interface to perform a registration of a user;
c. using the graphical user interface to receive from the user a designation of a plurality of political topics of interest to the user;
d. providing the user with information with respect to the designated plurality of political topics of interest to the user;
e. using the localization signal receiver to determine a location of the user; and
f assisting the user with the public activities using the determined location of the user and a time information.

16. The computerized system of claim 15, wherein assisting the user comprises showing the user a location of a voting booth.

17. The computerized system of claim 15, wherein assisting the user comprises showing the user a path a voting booth.

18. The computerized system of claim 15, wherein assisting the user comprises performing a check-in of the user at a voting booth.

19. The computerized system of claim 15, wherein assisting the user comprises receiving information from the user on user's voting choices and aggregating the received information in a database.

20. The computerized system of claim 15, wherein assisting the user comprises enabling a user to invite friends.
